(19) United States
(12) Patent Application Publication
(10) Pub. No.: US 2026/0273999 A1
(43) Pub. Date: Sep. 17, 2026

(54) IRRIGATION WHEEL WITH PIVOTING FOOT PADS

(71) Applicant: Unverferth Manufacturing Co., Inc., Kalida, OH (US)

(72) Inventors: Brian J. PETERSEN, Hamler, OH (US); Michael J. HILVERS, Fort Jennings, OH (US)

(73) Assignee: Unverferth Manufacturing Co., Inc., Kalida, OH (US)

(21) Appl. No.: 19/556,607

(22) Filed: Mar. 4, 2026

Related U.S. Application Data
(60) Provisional application No. 63/773,092, filed on Mar. 17, 2025.

(51) Int. Cl. B60B 15/20; A01G 25/09; B60B 3/14

(52) U.S. Cl. CPC B60B 15/20; B60B 3/14; A01G 25/09; B60B 2200/00; B60B 2360/50; B60B 2900/721

(57) ABSTRACT

A wheel for a movable irrigation system includes a center disc mounted for rotation about a wheel axis and a plurality of pads mounted to the center disc at positions on an outer periphery of the center disc. Each pad is mounted to the outer periphery of the center disc so as to enable the pad to pivot about a first pivot axis that is parallel to the wheel axis and to deflect laterally about a second pivot axis that is perpendicular to the wheel axis. In one example, each pivot pad is mounted to the center disc by a pivot pin extending through a pivot tube that enables the pad to pivot about the first pivot axis, and the pivot pin is captured in an elastomeric bushing disposed within the pivot tube that enables the pad to deflect about the second pivot axis.

This application claims the benefit under 35 U.S.C. § 119(e) of the filing date of U.S. provisional patent application Ser. No. 63/773,092 filed Mar. 17, 2025, the disclosure of which is incorporated herein by reference.

### FIELD OF THE DISCLOSURE

This disclosure relates to wheels for self-propelled irrigation systems. More particularly, the disclosure relates to wheels with pivoting pads attached to a periphery of a center disc of the wheel, wherein each pad is pivotable about a first pivot axis that is parallel to the axis of rotation of the wheel and a second pivot axis that is perpendicular to the axis of rotation of the wheel and parallel to the plane of the center disc. Each pad may be formed to have a concave inner surface and a convex outer surface.

### BACKGROUND

Self-propelled irrigation systems, such as center pivot irrigation systems, linear irrigation systems, or corner irrigation systems, include support towers that support one or more water supply pipe and nozzle above the ground and carry the irrigation system over the field to be irrigated. Each irrigation tower is supported by one or more wheels, allowing the tower to be propelled across the surface of the field. Irrigation towers used in agricultural fields have traditionally used common rubber tires and wheels for carrying and driving the towers through the field. Rubber tires have some inherent drawbacks, as they cause ruts in the dirt as they travel over and over the same path in the field and are high maintenance. In a cross section of a tire parallel to the wheel's axis of rotation, rubber irrigation tower tires have a convex, rounded tread shape. As the tires traverse through wet soils, the tire shape tends to push the dirt out to the sides of the tires. Each irrigation tower travels through the very same tire track many times during a growing season. This tendency of each tire to push dirt to the side causes deeper and deeper ruts upon every pass of the tire. These tires are also high maintenance, as the tire pressure needs to be constantly maintained, and the tires are continuously exposed to sunlight, which degrades the rubber, causing it to crack and break, thereby requiring replacement of the tire. Rubber tires regularly go flat due to wear or puncture. Accessing an irrigation tower tire for maintenance and repairs can be very challenging due to muddy field conditions and growing crops. Typical repairs of a conventional rubber tire require a jack to take the weight off of the wheel and lift the wheel off the ground.

For these reasons, a need exists for an alternative for these rubber tires/wheels.

A number of steel wheel configurations have been tried as alternatives for rubber tires, but such wheels also have problems. A steel wheel can be very rigid, and even if it has rubber pads attached to its outer surface, such wheels provide a very rough ride for the irrigation tower due to the faceted circumference of the wheel, and that rough ride can result in damage to the drivetrain of the irrigation system as well as to all components supported by these rigid wheels. In addition, such wheels still cause ruts as the faceted circumference of the wheel results in point loading at each pad.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The irrigation wheel disclosed herein includes a rigid (e.g., steel) center disc with pivoting outer pads secured about the circumference of the wheel. Each pad is pivotable about a first pivot axis that is parallel to the axis of rotation of the wheel and a second pivot axis that is perpendicular to the axis of rotation of the wheel and parallel to the plane of the center disc. Each pad may be formed to have a concave inner surface and a convex outer surface. The center disc attaches to a hub on the irrigation tower in the same manner a typical wheel does. In one example described herein, bushings are positioned near the outer circumference of the disc, and the pivoting pads are attached to the bushings. The bushings create the pivot point for the outer pads of the wheel. The bushings are configured to allow each pad to pivot about the first axis and the second axis.

As the wheel rotates, the outer pads come in contact with the ground to support the weight of the machine and propel it forward. As each outer pad comes in and out of contact with the ground as the center disc rotates, the outer pad pivots about the first axis that is parallel to the rotation of the wheel. This first pivot axis allows the pad to set down generally flat on the ground as it contacts the ground, which reduces the faceted effect, thereby smoothing out the ride of the wheel and reduces the tendency of the outer pad to push dirt forward. In addition, an elastomeric bushing inside the pivot allows that pad to camber side to side (about the second pivot axis that is perpendicular to the axis of rotation of the wheel). Pivoting in the side-to-side direction about the second pivot axis allows the pad to conform to the contour of the ground or traverse over obstacles, such as rocks or large dirt clods, encountered by the wheel. The combination of the first and second pivot directions of each pad allows the wheel to traverse muddy, rocky, uneven terrain with minimum soil disturbance and helps to smooth out the ride to minimize the stress on the driveline of the machine to which it is attached.

A wheel for a movable irrigation system as disclosed herein may include a center disc configured to be mounted to a portion of the irrigation system for rotation about a wheel axis and defining an outer periphery and a plurality of pads mounted to the center disc at circumferentially spaced positions on the outer periphery. Each of the plurality of pads has an inner surface facing the center disc and an outer surface facing outwardly from the center disc, and each pad is mounted to the outer periphery of the center disc so as to enable the pad to pivot about a first pivot axis that is parallel to the wheel axis and to deflect laterally about a second pivot axis that is perpendicular to the wheel axis.

According to another aspect of the wheel disclosed herein, each pad may be mounted to the outer periphery of the center disc by a pivot pin disposed within a pivot tube so as to enable the pad to pivot about the first pivot axis, wherein an inner diameter of the pivot tube may be greater than an outer diameter of the pivot pin, and wherein an elastomeric bushing may be disposed between the outer diameter of the pivot pin and the inner diameter of the pivot tube to enable the pad to deflect laterally about the second pivot axis.

According to another aspect, the wheel disclosed herein may include first and second brackets extending from the inner surface of the pivot pad and spaced apart by a distance greater than a length of the pivot tube, and the pivot pin may extend through openings formed in the first and second brackets.

According to another aspect, the wheel disclosed herein may include a first extension tube extending from the opening formed in the first bracket in a direction away from the second bracket, a second extension tube extending from the opening formed in second bracket in a direction away from first bracket, wherein the pivot pin may have a head at one end having a diameter greater than a diameter of first extension tube, and a retainer pin inserted through aligned, radial oriented holes formed through second extension tube aligned with a transverse through hole formed in pivot pin.

According to another aspect of the wheel disclosed herein, each pad may have a trapezoidal shape defined by parallel first and second sides that are generally perpendicular to the wheel axis and first and second ends that are oriented at an angle with respect to the wheel axis.

According to another aspect of the wheel disclosed herein, the first and second ends may be angled away from the center disc, thereby defining first and second raised ribs at the first and second ends, respectively, of the pad.

According to another aspect of the wheel disclosed herein, a top edge of each of the raised ribs may be serrated.

According to another aspect, the wheel disclosed herein may include a third raised rib extending across the outer surface of the pad from the first side of the pad to the second side of the pad.

According to another aspect of the wheel disclosed herein, a top edge of the third raised rib may be serrated.

According to another aspect of the wheel disclosed herein, the third raised rib may be curved or may be oriented at a different angle relative to the wheel axis than the first raised rib and the second raised rib.

According to another aspect of the wheel disclosed herein, each pad may be formed so that the inner surface of the pad is concave and the outer surface of the pad is convex.

According to another aspect of the wheel disclosed herein, the pad may be formed by a smooth curve between first and second ends of the pad or by two or more bends between the first and second ends of the pad.

According to another aspect of the wheel disclosed herein, the center disc and the pivot pads may be formed from steel.

According to another aspect of this disclosure, an irrigation system comprises one or more of the wheel disclosed herein.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 is a schematic view of a portion of a self-propelled irrigation system including a support tower including two irrigation wheels as disclosed herein.

FIG. 2 is a front perspective view of an irrigation wheel as described herein.

FIG. 3 is a rear perspective view of the irrigation wheel with a pivot pad shown in an exploded position with respect to the rest of the irrigation wheel.

FIG. 4 is a front view of the irrigation wheel.

FIG. 5 is a cross-section of the irrigation wheel along the line A-A in FIG. 4.

FIG. 6 is Detail B of FIG. 5.

FIG. 7 is Detail C of FIG. 3.

FIG. 8 is a top perspective view of a pivot pad.

FIG. 9 is a top plan view of the pivot pad.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

### Definitions

Unless defined otherwise, all terms of art, notations and other technical terms or terminology used herein have the same meaning as is commonly understood by one of ordinary skill in the art to which this disclosure belongs. Any patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

References in the specification to “one embodiment,” “an embodiment,” a “further embodiment,” “an example,” “an exemplary embodiment,” “some aspects,” “a further aspect,” “aspects,” etc. indicate that the embodiment, example, or aspect described may include a particular feature, structure, or characteristic, but every embodiment encompassed by this disclosure may not necessarily include the particular feature, structure, or characteristic or combination thereof. Moreover, such phrases are not necessarily referring to the same embodiment, example, or aspect. Further, when a particular feature, structure, or characteristic is described in connection with an embodiment, such feature, structure, or characteristic is also a description in connection with other embodiments, examples, or aspects with which it is not incompatible, whether or not explicitly described.

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise indicated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, forward, backward, sideward, sideways, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship, in which the first component, structure, or portion thereof is in direct contact with the second component, structure, or portion thereof, or an indirect relationship, in which there are one or more intervening components, structures, or portions thereof between the first component, structure, or portion thereof and the second component, structure, or portion thereof.

Unless otherwise stated, any specific dimensions mentioned in this description are merely representative of an exemplary implementation of a device embodying aspects of the disclosure and are not intended to be limiting.

To the extent used herein, the terms “about,” “approximately,” or similar terms apply to all numeric values and terms indicating specific physical orientations or relationships, such as horizontal, vertical, parallel, perpendicular, concentric, or similar terms, specified herein, whether or not explicitly indicated. Such terms generally refer to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of ±10 percent of the given numeric value, orientation, or relationship, provided such a deviation does not alter the end function or result of the stated value, orientation, or relationship. Therefore, under some circumstances as would be appreciated by one of ordinary skill in the art, a value of about or approximately 1% can be construed to be a range from 0.9% to 1.1%.

To the extent used herein, the term “adjacent” refers to being near (spatial proximity) or adjoining (physical contact). Adjacent objects or portions thereof can be spaced apart from one another or can be in actual or direct physical contact with one another. In some instances, adjacent objects or portions thereof can be coupled to one another or can be formed integrally with one another.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

To the extent used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

To the extent used herein, the term or phrase “configured to,” “adapted to,” “operable to,” “constructed and arranged to,” and similar terms mean that the subject of the term or phrase includes, constitutes, or otherwise encompasses the requisite structure(s), mechanism(s), arrangement(s), component(s), material(s), algorithm(s), circuit(s), programming, etc. to perform a specified function, task, or tasks or achieve a specified output or characteristic, either automatically or perpetually or selectively when called upon to do so.

All possible combinations of elements and components described in the specification or recited in the claims are contemplated and considered to be part of this disclosure. It should be appreciated that all combinations of the foregoing concepts and additional concepts discussed in greater detail herein (provided such concepts are not mutually inconsistent) are contemplated as being part of the inventive subject matter described herein. In particular, all combinations of claimed subject matter appearing at the end of this disclosure are contemplated as being part of the inventive subject matter disclosed herein.

### DESCRIPTION OF THE DRAWINGS

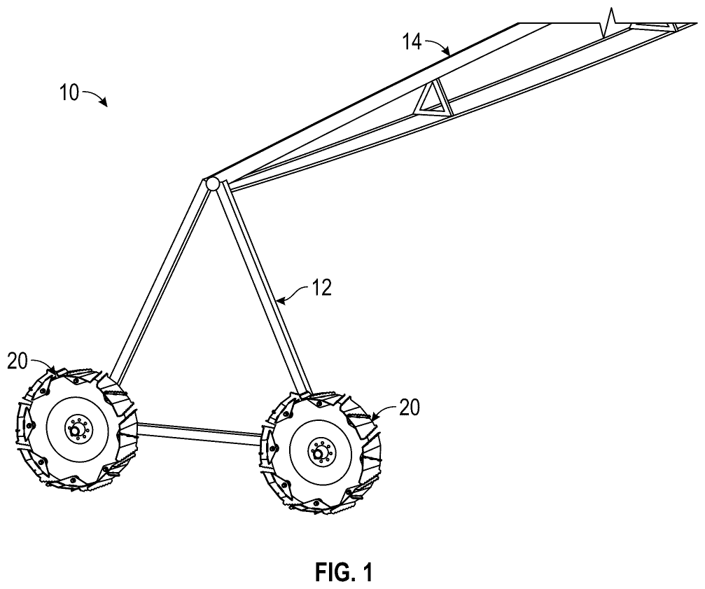

FIG. 1 is a schematic view of a portion of a movable (e.g., self-propelled) irrigation system 10 including a tower 12 (e.g., one of multiple towers, not shown) supporting a water pipe 14 and including two irrigation wheels 20.

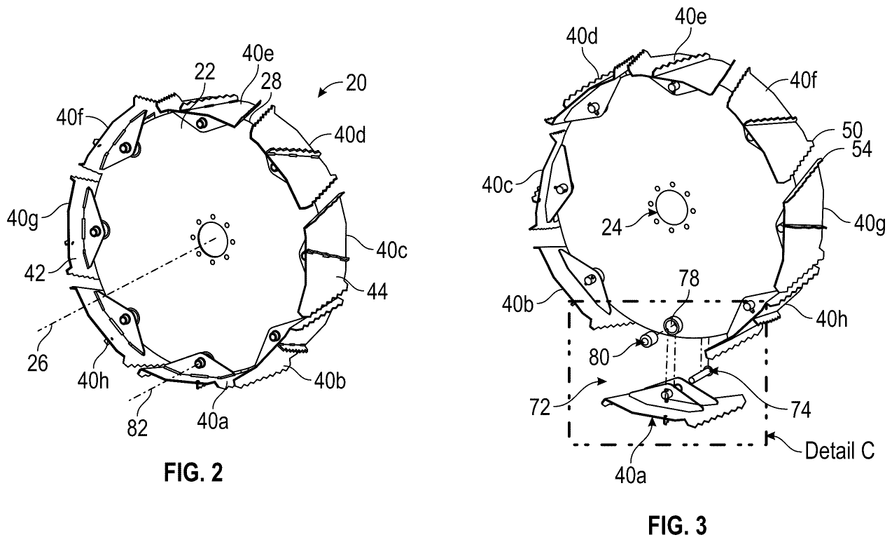

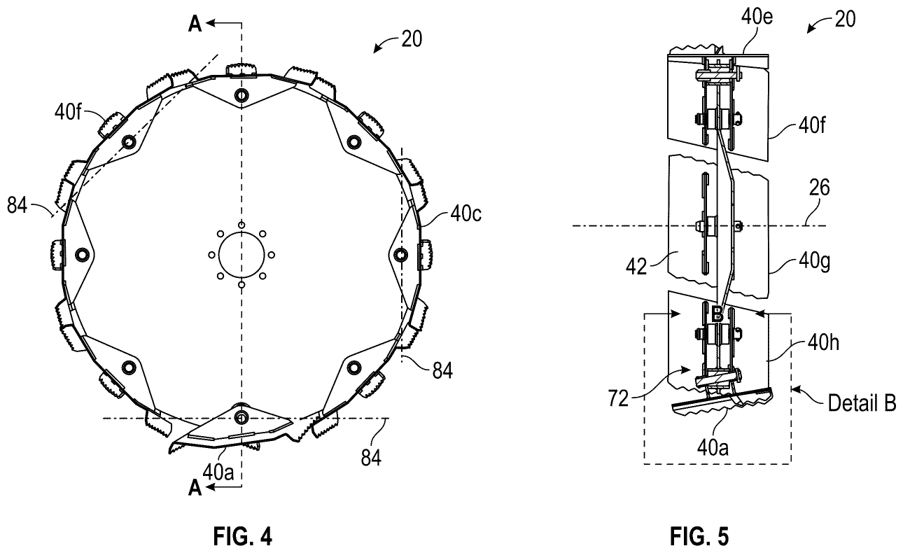

FIG. 2 is a front perspective view of an irrigation wheel 20, FIG. 3 is a rear perspective view of irrigation wheel 20, and FIG. 4 is a front view of irrigation wheel 20. Irrigation wheel 20 includes a center disc 22 with a hub 24, by which wheel 20 is secured-e.g., in a conventional manner-to a rotatable hub of the tower 12 or other portion of irrigation system 10, and a plurality of pivot pads 40a, 40b, 40c, 40d, 40e, 40f, 40g, and 40h secured to the circumference, or outer periphery, 28 of the center disc 22. As each of pads 40a-40h is identical in the drawings (but need not actually be identical in practice), a pivot pad may be referred to in this disclosure by reference number 40 with the letter designation a-h omitted. Each pivot pad 40 includes an inner side, or surface, 42 (labeled on pivot pad 40g in FIG. 2) facing the center disc 22 and an outer side, or surface, 44 (labeled on pivot pad 40c in FIG. 2) facing away from the center disc 22. Center disc 22 is rotatable about a wheel axis 26 and may be straight (flat or planar) or formed to provide added rigidity. Center disc 22 may be made from any material having sufficient strength, including steel, composite, or rubber.

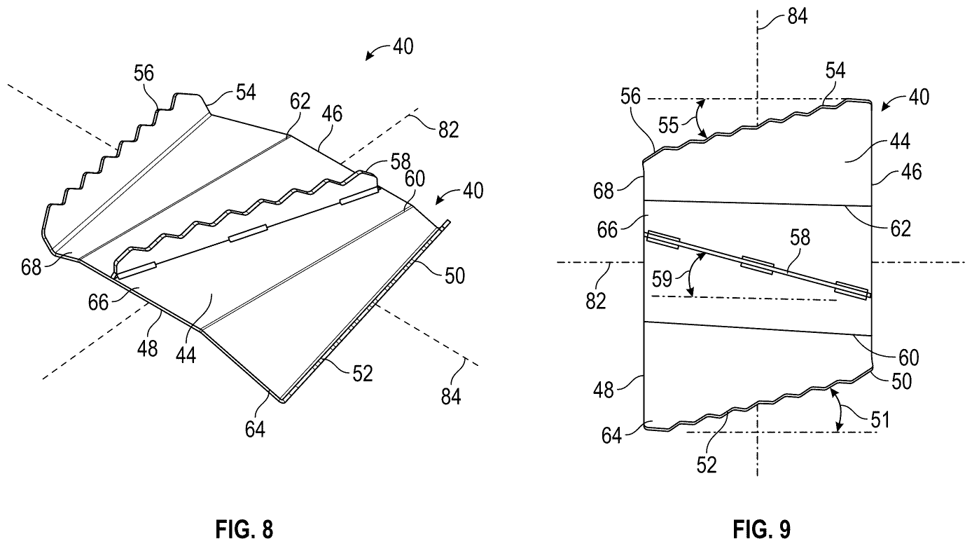

FIG. 8 is a top perspective view of a single pivot pad 40 representative of any one of pivot pads 40a-40h shown in FIG. 1, and FIG. 9 is a top plan view of pivot pad 40. Each pad may be made from a material having sufficient strength, including steel, composite, or rubber. As shown in FIGS. 8 and 9, each pivot pad 40 has a trapezoidal shape and includes a first edge 46 and a second edge 48 that are generally parallel to one another and are generally parallel to a plane of the center disc 22. A first end 50 and a second end 54 are generally parallel to each other and are oriented at an angle 51, 55 of 5 degrees to 45 degrees with respect to perpendicular to the first and second edges 46, 48 (i.e., ends 50 and 54 are not parallel to wheel axis 26). First end 50 may be bent, or otherwise redirected, upwardly away from center disc 22 to form a first rib 52, which may have a serrated, or scalloped, edge. Similarly, second end 54 may be bent, or otherwise redirected, upwardly away from center disc 22 to form a second rib 56, which may also have a serrated, or scalloped, edge. First and second ribs 52, 56 function as treads or grips for the pivot pad 40. Pivot pad 40 may also include an optional third rib 58 extending across the outer side 44 from first edge 46 to second edge 48 and oriented at an angle 59 (e.g., 5 degrees to 45 degrees) (i.e., not parallel to wheel axis 26) which may be different than angles 51, 55. Third rib 58 may have a serrated, or scalloped, top edge and function as an additional tread or grip for the pivot pad 40. The pivot pads are constructed and arranged so that the first end 50 of each pivot pad is generally parallel to the second end 54 of a circumferentially adjacent pivot pad so that adjacent pivot pads have interlacing faces. This is illustrated in FIG. 3 in which first end 50 of pivot pad 40f is generally parallel to second end 54 of adjacent pivot pad 40g. Third rib 58 may be curved, instead of straight as shown, and each pad 40 may may have two or more additional ribs on the outer side 44 between the first and second ribs 52, 56. The angled ribs and pad ends, which are not parallel to the wheel axis 26, provide a nearly smooth circumference of the wheel 20 as no edges are parallel to the wheel axis 26 so that the wheel 20 tends to walk across the ground, rather than stomping or flopping from pad to pad as the wheel 20 rotates.

The pivot pads 40 may be shaped so as to have a generally convex outer side 44 and a concave inner side 42. In one example, the pivot pads have a curved shape with a curvature that is complementary to a curvature of the outer periphery 28 of the center disc 22. In another example, each pivot pad 40 may have two or more bends to emulate an arced surface. As shown in FIGS. 8 and 9, pivot pad 40 has a first bend 60 and a second bend 62, thereby forming a first facet 64, a second facet 66, and a third facet 68.

Each of pivot pads 40a-40h is mounted to the center disc 22 at circumferentially spaced positions on the outer periphery 28 by an attachment 72 configured to enable the pad to pivot about a first pivot axis 82 that is typically parallel to the wheel axis 26 (see FIGS. 8 and 9 and labeled for pivot pad 40a in FIG. 2) and to deflect, or pivot, laterally about a second pivot axis 84 that is perpendicular to the wheel axis 26 (see FIGS. 8 and 9 and labeled for pivot pads 40a, 40c, and 40f in FIG. 4).

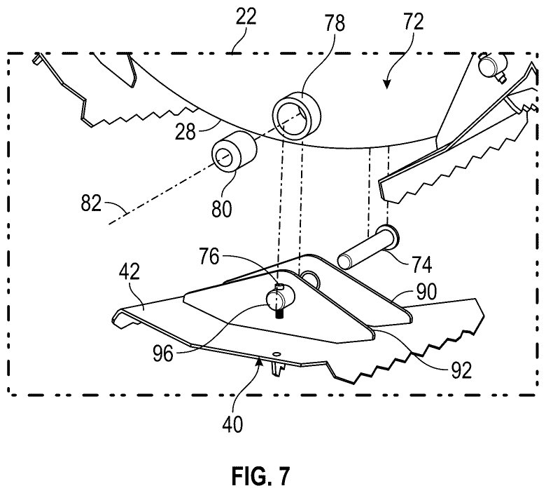

As shown in FIGS. 3, 5, 6, and 7, in one example, attachment 72 comprises a pivot tube 78 extending through and attached to, e.g., by welding, to the center disc 22 near the outer periphery 28, first and second brackets 90, 92 extending upwardly from the inner side 42 of the pad 40, and a bushing 80 made of an elastomeric material, such as rubber having a hardness (durometer) of, for example, 40 A to 100 A, inserted into the pivot tube 78. Brackets 90, 92 are spaced apart by a distance somewhat greater than the length of the pivot tube 78 and are positioned with one bracket on each side of the pivot tube 78. A first extension tube 94 extends from an opening formed in first bracket 90 in a direction away from second bracket 92, and a second extension tube 96 extends from an opening formed in second bracket 92 in a direction away from first bracket 90. A pivot pin 74 is inserted through first extension tube 94 and the hole formed in first bracket 90, through the bushing 80, and then through the hole formed in second bracket 92 and second extension tube 96. Pivot pin 74 has a head at one end having a diameter greater than the diameter of first extension tube 94. Pivot pin 74 may be secured within the attachment 72 by a retainer pin 76 inserted through aligned, radially oriented holes formed through second extension tube 96 aligned with a transverse (radial) through hole formed in pivot pin 74.

In one, non-limiting example, the pivot pin has a diameter ranging 0.6 inch to 1.25 inch (e.g., about 1.0 inch). The elastomeric bushing may have an inside diameter of about 1.03 inch to provide a slip fit with the 1.0 inch pivot pin. That same elastomeric bushing may have an outside diameter of about 2.0 inches to fit within the pivot tube having an inside diameter of about 2.03 inches. These sizes could all be adjusted based on the size of the pivot pin 74 and size of the elastomeric bushing 80 used. The components merely need to provide a fit that allows the pads 40 to pivot as described.

Accordingly, a damaged pivot pad 40 and/or a damaged bushing 80 can be replaced simply by rotating the wheel 20 so that the pad 40 is not on the ground, removing the retainer pin 76, pulling the pivot pin 74 out of the brackets 90, 92, the pivot tube 78, and bushing 80, and separating the pad 40 from the center disc 22. A replacement pad 40 and/or a replacement bushing 80 can then be installed.

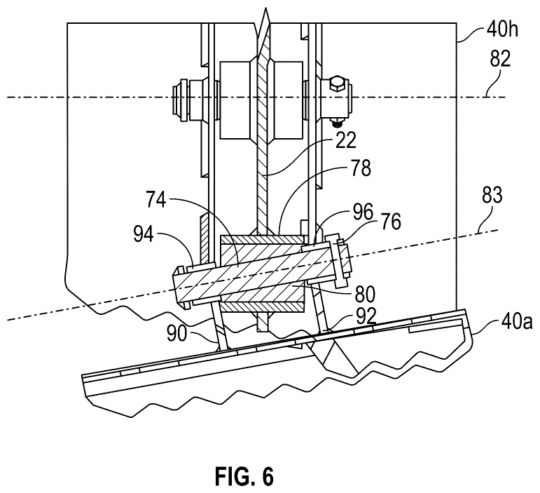

Pivot pin 74 extending through extension tubes 94, 96 formed in brackets 90, 92 allows the pivot pad 40 to pivot about first pivot axis 82. As shown in FIG. 6, the compressibility of the bushing 80 disposed between an inner diameter of the pivot tube 78 and an outer diameter of pivot pin 74 allows the pivot pin 74 to deflect into a position in which first pivot axis (here labeled as reference number 83) is no longer parallel with wheel axis 26, thereby enabling the pivot pad 40 to deflect, or pivot about second axis 84.

In an alternate example, attachment 72 comprises a ball joint (not shown) connecting each pad 40a-40h to center disc and enabling each pad to pivot about first pivot axis 82 and to deflect, or pivot, laterally about second pivot axis 84.

While the subject matter of this disclosure has been described and shown in considerable detail with reference to certain illustrative examples, including various combinations and sub-combinations of features, those skilled in the art will readily appreciate other embodiments and variations and modifications thereof as encompassed within the scope of the present disclosure. Moreover, the descriptions of such examples, combinations, and sub-combinations is not intended to convey that the claimed subject matter requires features or combinations of features other than those expressly recited in the claims. Accordingly, the scope of this disclosure is intended to include all modifications and variations encompassed within the scope of the following appended claims.

1. A wheel for a movable irrigation system comprising:
a center disc configured to be mounted to a portion of the irrigation system for rotation about a wheel axis and defining an outer periphery; and
a plurality of pads mounted to the center disc at circumferentially spaced positions on the outer periphery, wherein each of the plurality of pads has an inner surface facing the center disc and an outer surface facing outwardly from the center disc, wherein each pad is mounted to the outer periphery of the center disc so as to enable the pad to pivot about a first pivot axis that is parallel to the wheel axis and to deflect laterally about a second pivot axis that is perpendicular to the wheel axis.

2. The wheel of claim 1, wherein each pad is mounted to the outer periphery of the center disc by a pivot pin disposed within a pivot tube so as to enable the pad to pivot about the first pivot axis, wherein an inner diameter of the pivot tube is greater than an outer diameter of the pivot pin, and wherein an elastomeric bushing is disposed between the outer diameter of the pivot pin and the inner diameter of the pivot tube to enable the pad to deflect laterally about the second pivot axis.

3. The wheel of claim 2, further comprising first and second brackets extending from the inner surface of the pivot pad and spaced apart by a distance greater than a length of the pivot tube, and wherein the pivot pin extends through openings formed in the first and second brackets.

4. The wheel of claim 3, further comprising:
a first extension tube extending from the opening formed in the first bracket in a direction away from the second bracket;
a second extension tube extending from the opening formed in second bracket in a direction away from first bracket, wherein the pivot pin has a head at one end having a diameter greater than a diameter of first extension tube; and
a retainer pin inserted through aligned, radially oriented holes formed through second extension tube aligned with a transverse through hole formed in the pivot pin.

5. The wheel of claim 1, wherein each pad has a trapezoidal shape defined by parallel first and second sides that are generally perpendicular to the wheel axis and first and second ends that are oriented at an angle with respect to the wheel axis.

6. The wheel of claim 5, wherein the first and second ends are angled away from the center disc defining first and second raised ribs at the first and second ends, respectively, of the pad.

7. The wheel of claim 6, wherein a top edge of each of the raised ribs is serrated.

8. The wheel of claim 7, further comprising a third raised rib extending across the outer surface of the pad from the first side of the pad to the second side of the pad.

9. The wheel of claim 8, wherein a top edge of the third raised rib is serrated.

10. The wheel of claim 9, wherein the third raised rib is curved.

11. The wheel of claim 9, wherein the third raised rib is oriented at a different angle relative to the wheel axis than the first raised rib and the second raised rib.

12. The wheel of claim 1, wherein each pad is formed so that the inner surface of the pad is concave and the outer surface of the pad is convex.

13. The wheel of claim 12, wherein the pad is formed by a smooth curve between first and second ends of the pad or by two or more bends between the first and second ends of the pad.

14. The wheel of claim 1, wherein the center disc is formed from steel, composite, or rubber, and the pivot pads are formed from steel, composite, or rubber.

15. An irrigation system comprising one or more of the wheel of claim 1.
